(19) United States
(12) Patent Application Publication
(10) Pub. No.: US 2015/0099394 A1
(43) Pub. Date: Apr. 9, 2015

(54) CONNECTOR

(71) Applicant: YAZAKI CORPORATION, Tokyo (JP)

(72) Inventor: Kenichi IKEYA, Susono-shi (JP)

(73) Assignee: YAZAKI CORPORATION, Tokyo (JP)

(21) Appl. No.: 14/505,001

(22) Filed: Oct. 2, 2014

(30) Foreign Application Priority Data
Oct. 3, 2013 (JP) 2013-207904

(51) Int. Cl. H01R 13/52; H01R 13/02; H01R 33/945; H01R 13/60; H01R 13/73; H01R 9/18; H01R 13/58

(52) U.S. Cl. CPC H01R 13/5208; H01R 9/18; H01R 13/025; H01R 13/58; H01R 13/60; H01R 13/73; H01R 33/9453
USPC 439/533

(57) ABSTRACT

A connector includes: a mounting member having a case shape and a side wall with a through hole; a first connector placed outside the mounting member and having a first fitting portion; a second connector placed inside the mounting member and having a second fitting portion capable of fitting to the first fitting portion inserted from the through hole; a seal member placed on an outer periphery of the first connector and configured to be in close contact with the through hole with the first and second fitting portions fitted to each other and partition an inside and an outside of the mounting member from each other; and a holding unit provided on the mounting member and the second connector and configured to align the through hole and the second fitting portion with each other in position and hold the second connector to the mounting member.

### CROSS REFERENCE TO RELATED APPLICATION

This application is based upon and claims the benefit of priority from the prior Japanese Patent Application No. 2013-207904, filed on Oct. 3, 2013, the entire contents of which are incorporated herein by reference.

### BACKGROUND

1. Technical Field

The disclosure relates to a connector.

2. Related Art

JP 2002-151209 A discloses a connector including a partition wall as a mounting member having a through hole, a first connector, a second connector, and a grommet as a seal member. The first connector is placed on one side of the partition wall and includes a first fitting portion. The second connector is placed on the other side of the partition wall and includes a second fitting portion. The second fitting portion can be fitted to the first fitting portion which is inserted from the through hole. The grommet is provided on an outer periphery of the first connector, and is brought into close contact with the through hole in a state where the first fitting portion and the second fitting portion are fitted to each other, and the grommet partitions the one side and the other side of the partition wall from each other.

The grommet of the connector includes an inner shell cylindrical portion attached to an outer periphery of the first connector, an outer shell cylindrical portion attached to the through hole and concentrically placed on an outer periphery of the inner shell cylindrical portion through a space, and a bellows which connects the inner shell cylindrical portion and the outer shell cylindrical portion to each other.

Even if the second connector is mounted in a manner that it is deviated in a radial direction of the through hole or in a fitting direction with respect to the first connector, the grommet can absorb the mounting error by displacement of the grommet, and it is possible to reliably fit the first connector and the second connector to each other.

### SUMMARY

According to the above-described connector, since the second fitting portion of the second connector is not positioned with respect to the through hole of the mounting member, the mounting position of the second connector with respect to the mounting member is deviated in some cases. If the mounting position of the second connector with respect to the mounting member is deviated, a position of the second fitting portion with respect to the through hole is deviated, and a position of the first fitting portion of the first connector which is fitted to the second fitting portion is also deviated with respect to the through hole in accordance with the deviation of the position of the second fitting portion.

If the position of the first fitting portion is deviated with respect to the through hole, close contact between the seal member provided on the first connector and the through hole cannot uniformly be obtained, and waterproof property is deteriorated in some cases.

According to this connector, even if the position of the second fitting portion with respect to the through hole is deviated, it is possible to suppress the waterproof property from deteriorating by a structure for absorbing positional deviation provided in the seal member. However, the structure itself of the seal member is complicated.

It is an object of the present invention to provide a connector capable of securing waterproof property by a seal member with a simple structure.

A connector in accordance with some embodiments includes: a mounting member having a case shape and having a side wall with a through hole; a first connector placed outside the mounting member and having a first fitting portion; a second connector placed inside the mounting member and having a second fitting portion capable of fitting to the first fitting portion inserted from the through hole; a seal member placed on an outer periphery of the first connector and configured to be in close contact with the through hole with the first fitting portion and the second fitting portion being fitted to each other and partition an inside and an outside of the mounting member from each other; and a holding unit provided on the mounting member and the second connector, and configured to align the through hole and the second fitting portion with each other in position and hold the second connector to the mounting member.

According to this configuration, the mounting member and the second connector are provided with the holding unit which aligns positions of the through hole and the second fitting portion with each other and holds the second connector to the mounting member. According to this, positional deviation does not occur between the through hole and the second fitting portion, and the first fitting portion of the first connector which is fitted to the second fitting portion does not positionally deviate with respect to the through hole in accordance with the deviation of the position the second fitting portion.

Hence, the seal member provided on the first connector can constantly be in close contact with the through hole, and it is possible to secure waterproof property even if the seal member is not provided with the structure for absorbing positional deviation.

Therefore, according to the above-described connector, it is possible to secure the waterproof property by the seal member with a simple structure.

The holding unit may include a pair of ribs provided on one of the mounting member or the second connector, and a pair of grooves provided on the other one of the mounting member or the second connector and into which the pair of ribs is inserted.

According to this configuration, it is possible to prevent positional deviation between the through hole and the second fitting portion in any direction by inserting the ribs into the grooves, and it is possible to make the mounting member stably hold the second connector.

The first connector may include a fitting portion fixed to the side wall of the mounting member with the first fitting portion and the second fitting portion being fitted to each other.

According to this configuration, even if an external force is applied to the first connector, it is possible to prevent the first connector from moving with respect to the mounting member, and it is possible to stabilize the close contact between the seal member and the through hole and to secure the waterproof property.

According to this configuration, it is possible to provide a connector in which the structure of the seal member can be simplified and the waterproof property can be secured.

### BRIEF DESCRIPTION OF DRAWINGS

FIG. 1 is an exploded perspective view of a connector according to an embodiment of the present invention;

FIG. 2A is a perspective view when a first connector of the connector according to the embodiment of the invention is fitted;

FIG. 2B is a sectional view of a mounting member of the connector according to the embodiment of the invention;

FIG. 3A is a perspective view when the first connector of the connector according to the embodiment of the invention is fitted;

FIG. 3B is a sectional view of FIG. 3A;

FIG. 4 is a perspective view of the first connector of the connector according to the embodiment of the invention;

FIG. 5 is a perspective view of a second connector of the connector according to the embodiment of the invention;

FIG. 6 is a side view when the second connector and a substrate of the connector according to the embodiment of the invention are assembled together;

FIG. 7 is a perspective view when the second connector assembled on the substrate of the connector according to the embodiment of the invention is assembled on the mounting member;

FIG. 8 is a perspective view when the second connector assembled on the substrate of the connector according to the embodiment of the invention was assembled on the mounting member;

FIG. 9 is a perspective view when the second connector of the connector according to the embodiment of the invention is assembled on the mounting member; and

FIG. 10 is a perspective view when the second connector of the connector according to the embodiment of the invention was assembled on the mounting member.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for an embodiment of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

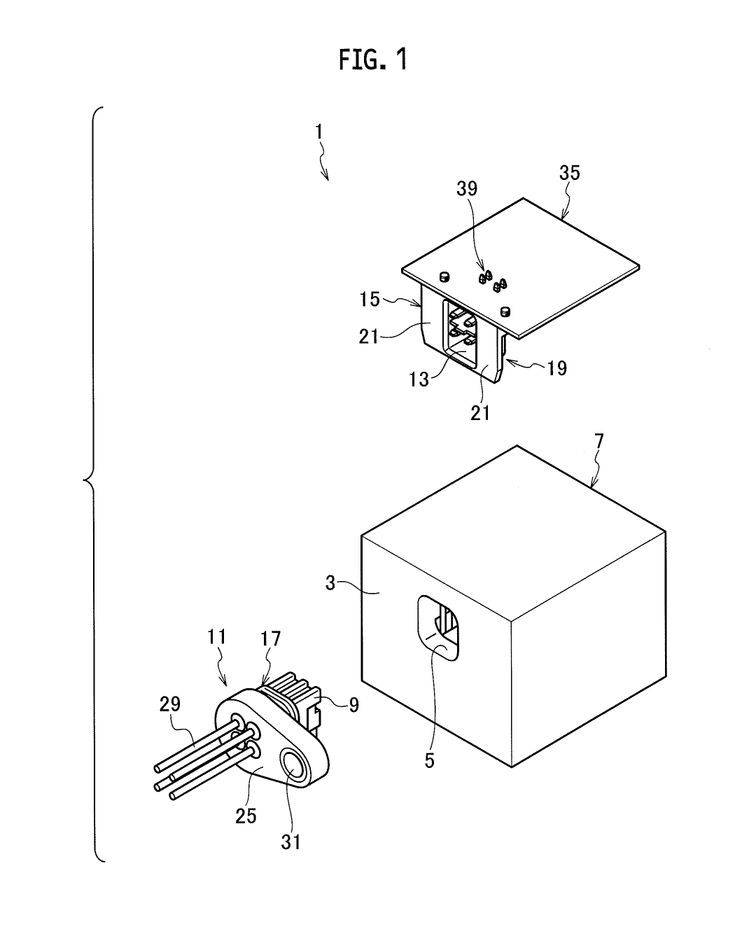

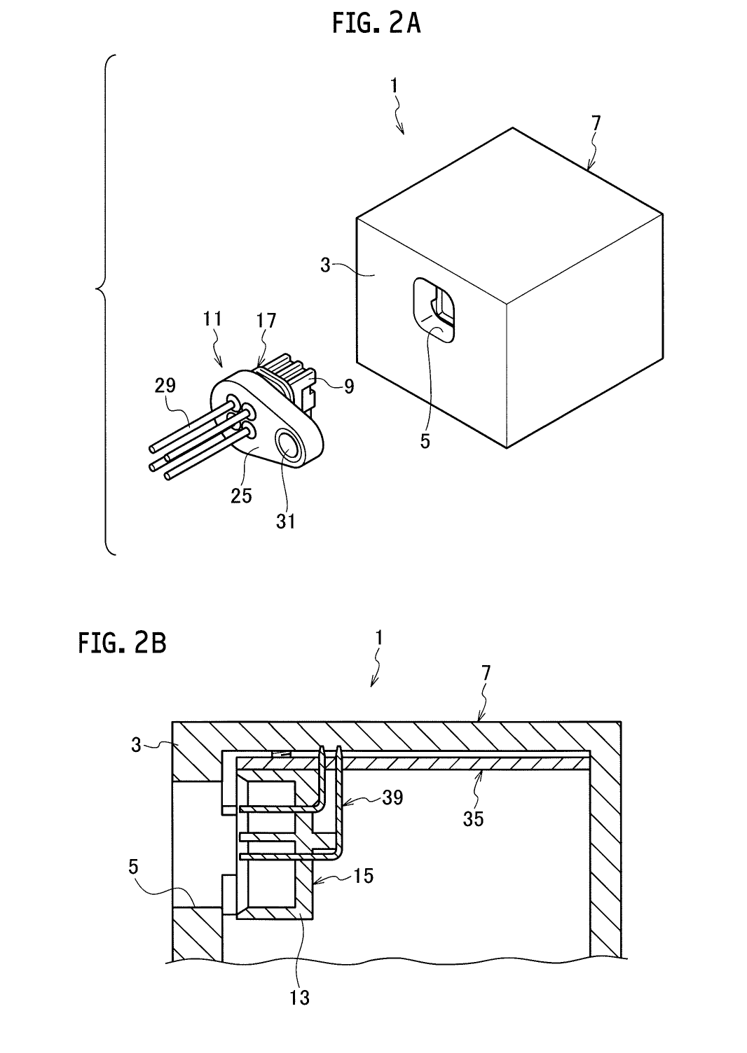

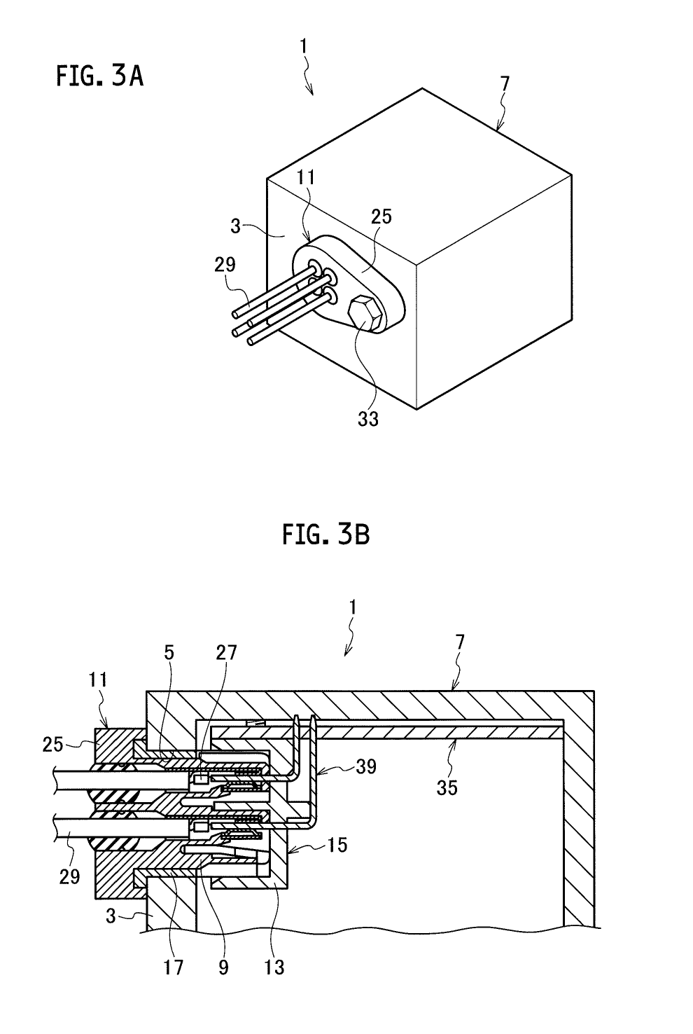

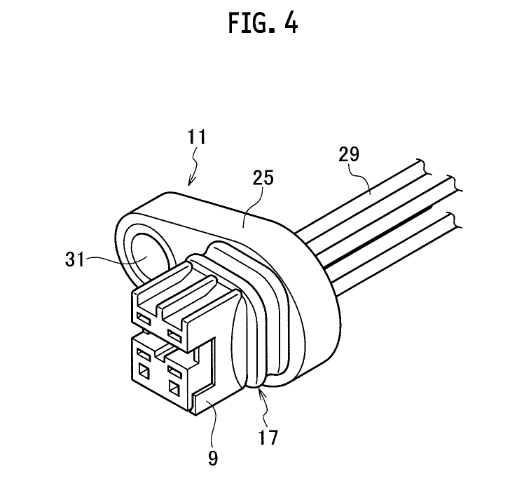

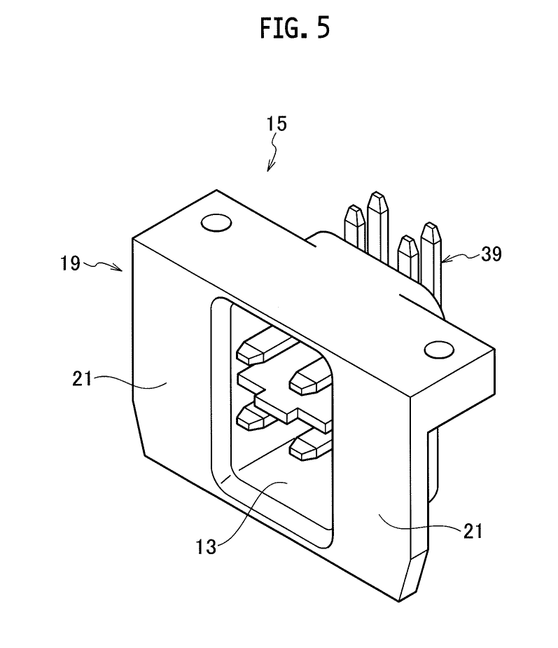

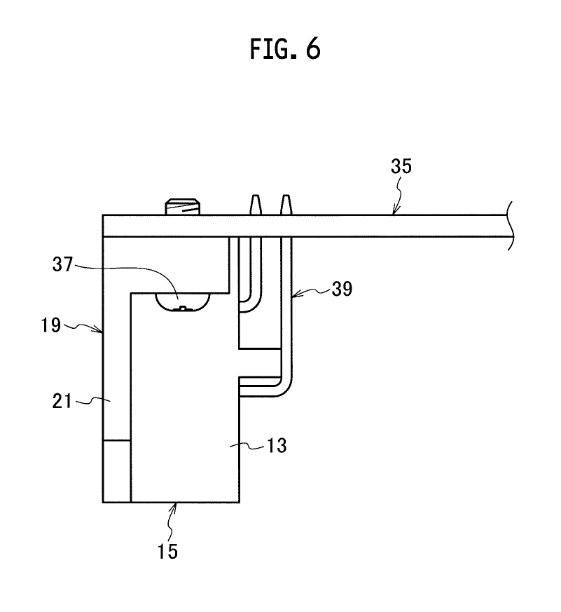

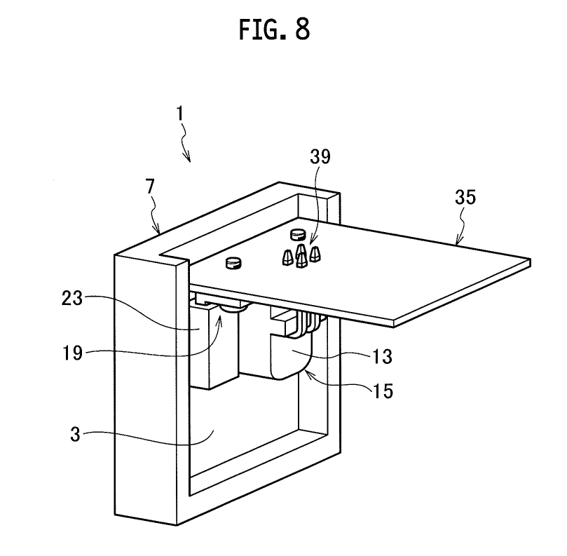

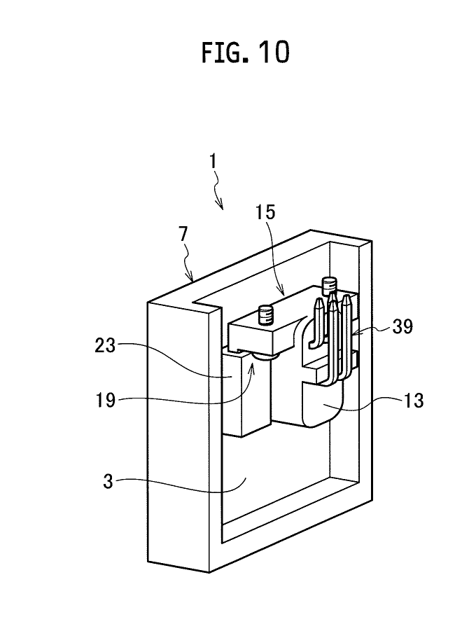

A connector 1 according to an embodiment of the present invention will be described using FIGS. 1 to 10.

The connector 1 includes a case-shaped mounting member 7, a first connector 11, a second connector 15 and a seal member 17. A side wall 3 of the mounting member 7 has a through hole 5. The first connector 11 is placed outside the mounting member 7, and includes a first fitting portion 9. The second connector 15 is placed inside the mounting member 7, and includes a second fitting portion 13 which can be fitted to the first fitting portion 9. The first fitting portion 9 is inserted from the through hole 5. The seal member 17 is provided on an outer periphery of the first connector 11. The seal member 17 is brought into close contact with the through hole 5 in a state where the first fitting portion 9 and the second fitting portion 13 are fitted to each other, thereby partitioning inside and outside of the mounting member 7 from each other.

The mounting member 7 and the second connector 15 are provided with a holding unit 19 for positionally aligning the through hole 5 and the second fitting portion 13 with each other and holding the second connector 15 to the mounting member 7.

The holding unit 19 has a pair of grooves 23, 23 into which a pair of ribs 21, 21 provided on the second connector 15 and a pair of ribs 21, 21 provided on the mounting member 7 can be inserted.

The first connector 11 is provided with a fixing portion 25 which is fixed to the side wall 3 of the mounting member 7 in a state where the first fitting portion 9 and the second fitting portion 13 are fitted to each other.

As shown in FIGS. 1 to 10, the mounting member 7 is formed into the case-shape, and a device (not shown) or the like is accommodated in the mounting member 7. The side wall 3 of the mounting member 7 is provided with the through hole 5, and inside and outside are brought into communication with each other through the through hole 5. The first fitting portion 9 of the first connector 11 is inserted into the through hole 5 from outside.

The first connector 11 is made of an insulating material such as synthetic resin, and includes the first fitting portion 9 and the fixing portion 25. The first fitting portion 9 is formed into a case-shape so that it can be inserted into the through hole 5, and first terminals 27 are accommodated in the first fitting portion 9. The first terminals 27 are composed of a female terminal having a box-shaped connecting portion.

The first terminals 27 are made of a conductive material, and are electrically connected to corresponding end portions of a plurality of electric wires 29 connected to a device, a power supply (not shown) or the like. The first fitting portion 9 is inserted into the through hole 5 of the mounting member 7 and the first fitting portion 9 is fitted to the second fitting portion 13 of the second connector 15. According to this, connecting portions of the second terminals 39 accommodated in the second fitting portion 13 are inserted into the first terminals 27, and the first terminals 27 and the second terminals 39 are electrically connected to each other.

The fixing portion 25 is formed of one material which is continuous with the first fitting portion 9 on the pulling-out side of the electric wires 29, and the fixing portion 25 is formed into a flange-shape so that it becomes larger than the through hole 5 of the mounting member 7. The fixing portion 25 is provided with a bolt-insertion hole 31. By fastening a bolt 33 in a state where the first fitting portion 9 of the first connector 11 and the second fitting portion 13 of the second connector 15 are fitted to each other, the fixing portion 25 is fixed to the side wall 3 of the mounting member 7.

By fixing the fixing portion 25 of the first connector 11 to the side wall 3 of the mounting member 7 in this manner, even if an external force such as a tensile force is applied to the electric wires 29, the fixing portion 25 can absorb the external force, and it is possible to suppress the influence exerted on the fitted state between the first fitting portion 9 of the first connector 11 and the second fitting portion 13 of the second connector 15.

The second connector 15 is made of an insulating material such as synthetic resin, and is formed into a case-shape. One end of the second connector 15 is opened. The second connector 15 is provided therein with the second fitting portion 13 to which the first fitting portion 9 of the first connector 11 is fitted.

The second connector 15 is placed on a surface of a substrate 35 which is a circuit substrate having a surface on which an electronic component (not shown) is mounted, and the second connector 15 is fixed to the substrate 35 through a fixing member 37 such as a screw. The connecting portions of the second terminals 39 are placed in the second fitting portion 13 of the second connector 15.

Each of the second terminals 39 is made of a conductive material and is formed into an L-shape. One end of the second terminal 39 is formed into a tab-shape, and the second terminal 39 is provided with the connecting portion placed in the second fitting portion 13. The other end of the second terminal 39 is provided with a substrate connecting portion which is electrically connected to a conductive portion of the substrate 35 through welding and the like.

The second connector 15 in which the second terminals 39 are accommodated is accommodated in the mounting member 7 in a state where the second connector 15 is assembled on the substrate 35. In this accommodated state, an opening of the second fitting portion 13 of the second connector 15 is located in the through hole 5 of the mounting member 7. By inserting the first fitting portion 9 of the first connector 11 from the through hole 5, the first fitting portion 9 and the second fitting portion 13 are fitted to each other, and the first terminals 27 and the second terminals 39 are electrically connected to each other.

The seal member 17 is provided on an outer periphery of the first connector 11 which is inserted into the through hole 5 of the mounting member 7.

The seal member 17 is made of an elastic material such as rubber and is formed into an annular shape. The seal member 17 is intimately attached to an outer periphery between the first fitting portion 9 and the fixing portion 25 of the first connector 11. An outer diameter of the seal member 17 is set larger than an inner diameter of the through hole 5.

By inserting the first fitting portion 9 of the first connector 11 into the through hole 5 of the mounting member 7, an outer peripheral surface of the seal member 17 is intimately placed on an inner peripheral surface of the through hole 5. By assembling the seal member 17 on the through hole 5, inside and outside of the mounting member 7 are partitioned from each other, and waterproof property between the mounting member 7 and the first connector 11 is secured.

According to the structure in which the seal member 17 is assembled on the through hole 5 of the mounting member 7, it is possible to secure the waterproof property by fastening evenly the outer peripheral surface of the seal member 17 to the inner peripheral surface of the through hole 5.

When the opening of the second fitting portion 13 of the second connector 15 positionally deviates with respect to the through hole 5 of the mounting member 7, the first fitting portion 9 of the first connector 11 which is fitted to the second fitting portion 13 also positionally deviates with respect to the through hole 5 in accordance with the deviation of the position of the second fitting portion 13.

If the first fitting portion 9 positionally deviates with respect to the through hole 5, it is not possible to fasten evenly the outer peripheral surface of the seal member 17 to the inner peripheral surface of the through hole 5, and the waterproof property is deteriorated.

The mounting member 7 and the second connector 15 are provided with the holding unit 19 for preventing the opening of the second fitting portion 13 of the second connector 15 from positionally deviating with respect to the through hole 5 of the mounting member 7.

The holding unit 19 includes the pair of grooves 23, 23 into which the pair of ribs 21, 21 provided on the second connector 15 and the pair of ribs 21, 21 provided on the mounting member 7 can be inserted.

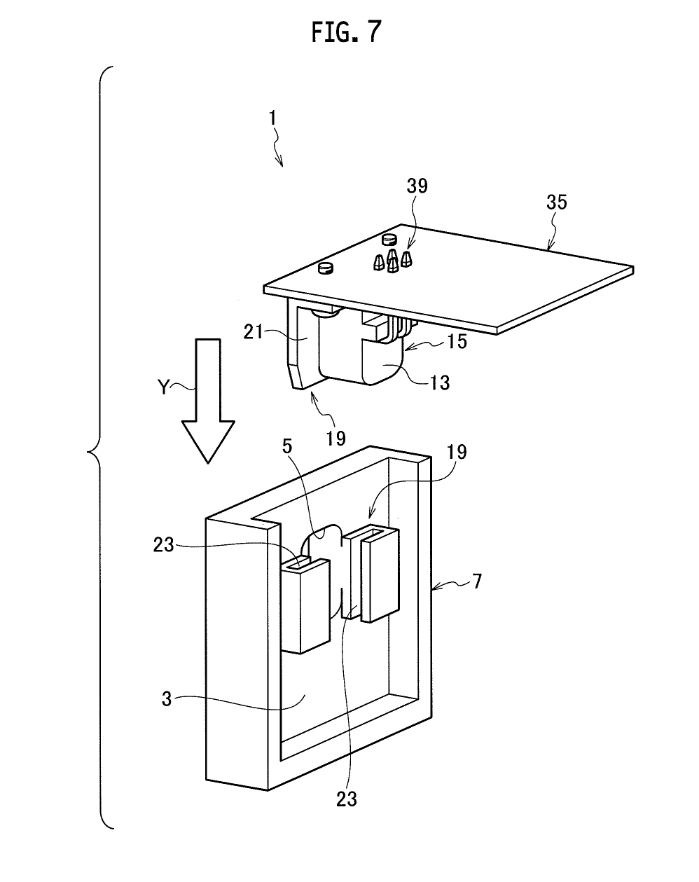

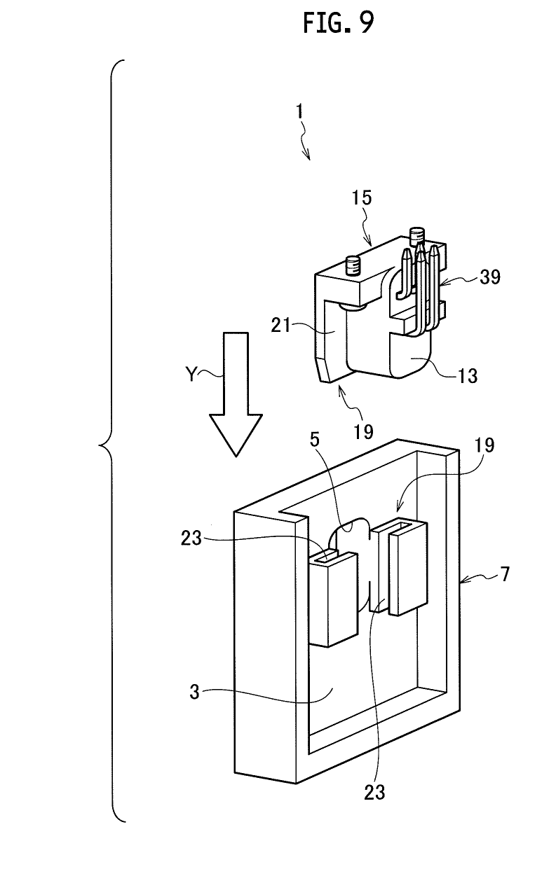

The pair of ribs 21, 21 extends from both sides of the opening edge of the second fitting portion 13 of the second connector 15 outward in the width direction, and each of the ribs 21, 21 is one member which is continuous from the second fitting portion 13. When the second connector 15 is accommodated in the mounting member 7, the pair of ribs 21, 21 is downwardly inserted into the pair of grooves 23, 23 from above in the height direction of the mounting member 7 as shown by arrows Y in FIGS. 7 and 9.

Front tip ends of the pair of ribs 21, 21 as viewed in the inserting direction are inclined so that the insertion into the pair of grooves 23, 23 is guided.

The pair of grooves 23, 23 is formed into a concave shape such that openings of the grooves 23, 23 are opposed to each other on both sides of the through hole 5 of the side wall 3 of the mounting member 7. Each of the grooves 23, 23 is one member which is continuous from the side wall 3. The pair of grooves 23, 23 covers peripheries of the pair of ribs 21, 21 in a state where the pair of ribs 21, 21 is inserted into the grooves 23, 23. At this time, upper surfaces of the pair of grooves 23, 23 abut against a lower surface of the second connector 15 which is located on the side of base ends of the pair of ribs 21, 21, thereby restricting the second connector 15 from moving downward in the height direction.

By inserting the pair of ribs 21, 21 into the pair of grooves 23, 23 in this manner, the second connector 15 is held by the mounting member 7 in a state where the opening of the second fitting portion 13 of the second connector 15 is aligned with the through hole 5 of the mounting member 7.

In a state where by the second connector 15 is held by the mounting member 7 through the holding unit 19, the pair of grooves 23, 23 is located around the pair of ribs 21, 21. Therefore, the second connector 15 is restricted from moving with respect to the mounting member 7 in any direction. Hence, the opening of the second fitting portion 13 of the second connector 15 does not positionally deviate with respect to the through hole 5 of the mounting member 7.

By preventing the second fitting portion 13 from positionally deviating with respect to the through hole 5 by the holding unit 19 in this manner, the first fitting portion 9 does not positionally deviate with respect to the through hole 5 in accordance with the deviation of the position of the second fitting portion 13. Hence, it is possible to fasten evenly the outer peripheral surface of the seal member 17 to the inner peripheral surface of the through hole 5.

In the connector 1 of the embodiment, the through hole 5 and the second fitting portion 13 are aligned with the mounting member 7 and the second connector 15 in position, and the holding unit 19 for holding the second connector 15 by the mounting member 7 is provided. According to this, positional deviation does not occur between the through hole 5 and the second fitting portion 13, and the first fitting portion 9 of the first connector 11 which is fritted to the second fitting portion 13 does not positionally deviate with respect to the through hole 5 in accordance with the deviation of the position of the second fitting portion 13.

Hence, it is possible to constantly bring the seal member 17 provided on the first connector 11 into close contact with the through hole 5, and it is possible to secure the waterproof property even if the seal member 17 is not provided with the structure for absorbing the positional deviation.

Therefore, according to the connector 1, it is possible to secure the waterproof property with the seal member 17 with a simple structure.

The holding unit 19 includes the pair of ribs 21, 21 and the pair of grooves 23, 23 into which the pair of ribs 21, 21 can be inserted. Hence, it is possible to prevent the positional deviation between the through hole 5 and the second fitting portion 13 in any direction by inserting the rib 21 into the groove 23, and the mounting member 7 can stably hold the second connector 15.

The first connector 11 is provided with the fixing portion 25 which is fixed to the side wall 3 of the mounting member 7 in a state where the first fitting portion 9 and the second fitting portion 13 are fitted to each other. Hence, even if an external force is applied to the first connector 11, it is possible to prevent the first connector 11 from moving with respect to the mounting member 7, intimate connection property between the seal member 17 and the through hole 5 can be stabilized, and waterproof property can be secured.

Although the second connector 15 is provided with the pair of ribs 21, and the mounting member 7 is provided with the pair of grooves 23 in the connector 1 of the embodiment of the present invention, the invention is not limited to this. For example, the second connector 15 may be provided with a pair of grooves corresponding to the pair of grooves 23, and the mounting member 7 may be provided with a pair of ribs corresponding to the pair of ribs 21.

Although the holding unit 19 includes the pair of ribs 21 and the pair of grooves 23, the invention is not limited to this. The holding unit 19 may include a single rib and a single groove. The holding unit 19 may include members, a convex portion and a concave portion for example, which engage with each other to align the second fitting portion and the through hole with each other in position.

Although the fixing portion 25 of the first connector 11 is fixed to the side wall 3 of the mounting member 7 through the bolt 33, the invention is not limited to this. The fixing portion 25 may be fixed to the side wall 3 of the mounting member 7 through adhesive bonding means, engaging means or the like.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

What is claimed is:

1. A connector comprising:
a mounting member having a case shape and having a side wall with a through hole;
a first connector placed outside the mounting member and having a first fitting portion;
a second connector placed inside the mounting member and having a second fitting portion capable of fitting to the first fitting portion inserted from the through hole;
a seal member placed on an outer periphery of the first connector and configured to be in close contact with the through hole with the first fitting portion and the second fitting portion being fitted to each other and partition an inside and an outside of the mounting member from each other; and
a holding unit provided on the mounting member and the second connector, and configured to align the through hole and the second fitting portion with each other in position and hold the second connector to the mounting member.

2. The connector according to claim 1, wherein the holding unit comprises:
a pair of ribs provided on one of the mounting member or the second connector; and
a pair of grooves provided on the other one of the mounting member or the second connector and into which the pair of ribs is inserted.

3. The connector according to claim 1, wherein the first connector comprises a fitting portion fixed to the side wall of the mounting member with the first fitting portion and the second fitting portion being fitted to each other.

4. The connector according to claim 2, wherein the first connector comprises a fitting portion fixed to the side wall of the mounting member with the first fitting portion and the second fitting portion being fitted to each other.
